(19) United States
(12) Patent Application Publication
(10) Pub. No.: US 2007/0254614 A1
(43) Pub. Date: Nov. 1, 2007

(54) SECURE WIRELESS CONNECTIONS USING SSID FIELDS

(75) Inventors: Kartik Muralidharan, Bangalore (IN); Puneet Gupta, Bangalore (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 11/741,534

(22) Filed: Apr. 27, 2007

(30) Foreign Application Priority Data
May 1, 2006 (IN) 789/CHE/2006

(51) Int. Cl. H04B 1/10

(52) U.S. Cl. 455/307

(57) ABSTRACT

Secure wireless connections can be established by broadcasting wireless security parameters within SSID fields. A wireless security parameter can be received and a broadcast SSID generated from the wireless security parameter. The broadcast SSID can be broadcast. Secure connections can be established with wireless devices that receive the broadcast SSID and connect using the broadcast SSID and the wireless security parameter. Secure wireless connections can also be established by broadcasting wireless security parameters and connection SSIDs within SSID fields. A wireless security parameter and a connection SSID can be received and a broadcast SSID generated from the wireless security parameter and connection SSID. The broadcast SSID can be broadcast. Secure connections can be established with wireless devices that receive the broadcast SSID and connect using the connection SSID and the wireless security parameter.

### BACKGROUND

Computing devices have traditionally communicated with each other using wired networks. However, with the increasing demand for mobile computing devices, such as laptops, personal digital assistants (PDAs), and the like, wireless computing networks have developed as a way for computing devices to communicate with each other through wireless transmission.

Wireless networks can be inherently less secure than wired networks because wireless transmissions can be received by any device within range of the transmission, regardless of whether the device is the intended recipient of the wireless transmission. In order to provide for secure wireless communications, various security solutions have been developed, such as Wired Equivalent Privacy (WEP) and Wi-Fi Protected Access (WPA).

While wireless security solutions can provide wireless security, they can be difficult to manage. For example, WEP and Wi-Fi Protected Access pre-shared key (WPA-PSK) solutions require that wireless devices be pre-configured with a key (a WEP key or a WPA-PSK) before establishing a secure wireless connection. In a static environment, this can be a simple task as the key can be pre-configured once and used thereafter. However, in a more dynamic wireless environment, such as an ad-hoc wireless network, or in a wireless environment in which the key, such as a WEP key or a WPA-PSK, changes, it can be much more difficult. For example, it can be impractical to distribute a new WEP key or WPA-PSK to every device each time the WEP key or WPA-PSK changes.

Therefore, there exists ample opportunity for improvement in technologies related to establishing secure wireless connections.

### SUMMARY

A variety of technologies related to establishing secure wireless connections using service set identifier (SSID) fields can be applied. For example, secure wireless connections can be established by broadcasting wireless security parameters within SSID fields. A wireless security parameter can be received and a broadcast SSID generated from the wireless security parameter (e.g., using an encryption algorithm). The broadcast SSID can be broadcast (e.g., by a broadcasting wireless device) within a wireless computing network. Secure connections can be established with wireless devices (e.g., client wireless devices) that receive the broadcast SSID and connect using the broadcast SSID and the wireless security parameter (e.g., decrypted from the broadcast SSID).

Secure wireless connections can also be established by broadcasting wireless security parameters and connection SSIDs within SSID fields. A wireless security parameter and a connection SSID can be received and a broadcast SSID generated from the wireless security parameter and connection SSID (e.g., using an encryption algorithm). The broadcast SSID can be broadcast (e.g., by a broadcasting wireless device) within a wireless computing network. Secure connections can be established with wireless devices (e.g., client wireless devices) that receive the broadcast SSID and connect using the connection SSID and the wireless security parameter (e.g., where the client wireless device decrypts the broadcast SSID to obtain the connection SSID and wireless security parameter).

An encryption algorithm can be used to encrypt wireless security parameters, or wireless security parameters along with connection SSIDs, to produce broadcast SSIDs. A corresponding decryption algorithm can be used to decrypt broadcast SSIDs to extract wireless security parameters, or to extract wireless security parameters along with connection SSIDs. A wireless encryption key can be used by an encryption, and corresponding decryption, algorithm.

The foregoing and other features and advantages of the invention will become more apparent from the following detailed description, which proceeds with reference to the accompanying figures.

### BRIEF DESCRIPTION OF THE DRAWINGS

FIG. 1 is a flowchart showing an exemplary method for establishing secure wireless connections.

FIG. 2 is a diagram showing exemplary encryption of a wireless security parameter.

FIG. 3 is a diagram showing exemplary decryption of a broadcast SSID.

FIG. 4 is a diagram showing an exemplary system for establishing secure wireless connections.

FIG. 5 is a diagram showing an exemplary system for establishing secure wireless connections by broadcasting wireless security parameters.

FIG. 6 is a flowchart showing an exemplary method for establishing secure wireless connections using wireless security parameters and connection SSIDs.

FIG. 7 is a diagram showing exemplary encryption of a wireless security parameter and connection SSID.

FIG. 8 is a diagram showing exemplary decryption of a broadcast SSID.

FIG. 9 is a flowchart showing an exemplary method for receiving encrypted broadcast SSIDs.

FIG. 10 is a block diagram illustrating an example of a computing environment that can be used to implement any of the technologies described herein.

### DETAILED DESCRIPTION OF EXEMPLARY EMBODIMENTS

### Example 1—Exemplary Wireless Computing Network

In any of the examples herein, a wireless computing network can be a wireless network based on the IEEE 802.11 standards, such as 801.11 a, 802.11b, 802.11g, 802.11n, etc. A wireless network based on the IEEE 802.11 standards can also be referred to as a WI-FI wireless network (Wi-Fi is a registered trademark of the Wi-Fi Alliance).

A wireless computing network can comprise various components. A wireless computing network can include wireless network adapters. For example, wireless network adapters can include wireless cards (e.g., WI-FI cards) in computers, PDAs, cell phones, smart phones, or other computing devices. Wireless network adapters can be built-in (e.g., a PDA with built-in, or integrated, wireless capability) or added (e.g., a laptop with a wireless network adapter card).

A wireless computing network can operate in infrastructure mode or ad-hoc mode. For example, a wireless network operating in infrastructure mode can comprise one or more access points and one or more client wireless devices connected to the access points. A wireless network operating in ad-hoc mode can comprise one or more wireless network devices connected in a peer-to-peer arrangement.

Secure connections can be established within a wireless computing network by broadcasting wireless security parameters within service set identifier (SSID) fields (broadcast in the SSID frame field of the beacon frame). For example, standard wireless access points and standard client wireless devices can include custom software and/or firmware to encrypt/decrypt wireless security parameters from broadcast SSIDs. Secure connections can also be established within a wireless computing network by broadcasting wireless security parameters and connection SSIDs within SSID fields. For example, standard wireless access points and standard client wireless devices can include custom software and/or firmware to encrypt/decrypt wireless security parameters and connection SSIDs from broadcast SSIDs.

In an infrastructure wireless network, access points (e.g., standard 802.11 access points) that include custom software and/or firmware (e.g., special-purpose access points) can encrypt wireless security parameters (e.g., alone or with connection SSIDs used to establish connections) to create broadcast SSIDs which can then broadcast, by the access points, as SSID values in SSID fields of beacon frames. The access points can then establish secure connections with client wireless devices that have received and decrypted the wireless security parameters (e.g., alone or with connection SSIDs).

In an ad-hoc wireless network, wireless devices (e.g., wireless devices comprising standard 802.11 wireless network adapters) that include custom software and/or firmware can encrypt wireless security parameters (e.g., alone or with connection SSIDs used to establish connections) to create broadcast SSIDs which the wireless devices can then broadcast as SSID values in SSID fields of beacon frames. The wireless devices can then establish secure connections with other wireless devices that have received and decrypted the wireless security parameters (e.g., alone or with connection SSIDs).

By encrypting wireless security parameters, alone or along with connection SSIDs, and broadcasting the encrypted information in SSID fields, wireless devices can quickly and easily establish secure wireless connections (e.g., when operating in ad-hoc mode). For example, both broadcasting and receiving wireless devices can be configured with corresponding encryption/decryption algorithms (e.g., using the same encryption key). If a wireless security parameter changes (e.g., a new WEP key or WPA-PSK is used), the new wireless security parameter can be broadcast in encrypted form in the broadcast SSID. Wireless devices receiving the broadcast SSID can decrypt the new wireless security parameter if the wireless devices have been configured with the decryption algorithm (e.g., along with the encryption key).

### Example 2—Exemplary Wireless Network Zone

In any of the examples herein, a wireless network zone can be a zone created by a wireless device. For example, a wireless network zone can be an area (e.g., a physical or geographic area) related to the communication range of a wireless adapter of the wireless device. For example, a wireless network adapter can have a range within which it can communicate with other wireless network adapters.

### Example 3—Exemplary Wireless Device

In any of the examples herein, a wireless device can be a computing device that is capable of wireless communication within a wireless computing network. For example, a wireless device can be a computing device such as a computer (e.g., a laptop, desktop, or tablet computer), a PDA, a mobile communications device (e.g., a cell phone or a smart phone), or another type of computing device with a built-in or add-on wireless network adapter (e.g., an 802.11 or WI-FI wireless network adapter). For example, a wireless device can be a laptop or PDA with an 802.11b or 802.11g wireless network adapter. Wireless devices can be mobile or stationary.

A wireless device can operate in infrastructure mode (e.g., a wireless network comprising access points and connected wireless devices) or ad-hoc mode (e.g., a number of wireless devices connected in a peer arrangement).

A wireless device can broadcast an SSID (e.g., a broadcasting wireless device). For example, a wireless device can broadcast an SSID comprising an encrypted wireless security parameter or comprising an encrypted wireless security parameter and connection SSID. A wireless device can be configured to automatically broadcast a broadcast SSID.

A wireless device can receive a broadcast SSID (e.g., a client wireless device). For example, the wireless device can receive the broadcast SSID, decrypt a wireless security parameter (and optionally a connection SSID), and use the decrypted information to establish a secure wireless connection.

A wireless device can comprise various wireless modules. For example, a wireless device, such as a wireless computing device, can comprise a wireless module (e.g., comprising hardware, software, or a combination) configured to perform various activities related to transmitting and/or receiving wireless communications (e.g., generating broadcast SSIDs, broadcasting broadcast SSIDs, encrypting and/or decrypting broadcast SSIDs, etc.).

### Example 4—Exemplary SSID Field

In any of the examples herein, SSID fields can be used for broadcasting encrypted information. The SSID field is a field of the 802.11 beacon frame (the beacon frame subtype of the management frame type). According to the 802.11 specification, the SSID field of the beacon frame identifies a wireless network. The SSID field contains up to 32 bytes of data.

Instead of broadcasting a standard SSID value in the SSID field, other types of information can be broadcast in the SSID field. For example, a wireless security parameter can be encrypted and the encrypted wireless security parameter can then be broadcast, as an SSID value, in the SSID field (e.g., taking the place of a standard SSID value). A wireless security parameter along with a connection SSID can also be encrypted and broadcast, as an SSID value, in the SSID field (e.g., taking the place of a standard SSID value). An SSID (e.g., SSID value) comprising encrypted information (e.g., an encrypted wireless security parameter or a combination of an encrypted wireless security parameter and connection SSID) can be called a broadcast SSID (e.g., a broadcast SSID value).

A broadcast SSID containing encrypted information can appear (e.g., to a wireless device or user receiving the broadcast SSID) to be no different from a standard (e.g., non-encrypted) SSID value.

### Example 5—Exemplary Encryption

In any of the examples herein, information can be encrypted and broadcast in SSID fields. Encryption refers to obscuring information in order to make the information difficult to decipher without special knowledge. Information can be encrypted using various encryption algorithms or functions, including cipher algorithms and steganographic techniques. Information that has been encrypted can be decrypted using a corresponding decryption algorithm. Some encryption/decryption algorithms require the use of an encryption key that is used to encrypt and decrypt the information. Other encryption/decryption algorithms do not require the use of an encryption key.

Encryption can be used to obscure wireless network connection information (e.g., wireless security parameters and/or connection SSIDs) so that unauthorized wireless devices cannot connect to the wireless network. For example, encryption can be used to obscure wireless security parameters, which can be broadcast as broadcast SSIDs. Encryption can also be used to obscure combinations of wireless security parameters and connection SSIDs, which can also be broadcast as broadcast SSIDs.

A simple encryption algorithm can be used to encrypt/decrypt wireless network connection information. For example, in a specific implementation, a wireless device accepting secure wireless connections implements a simple encryption algorithm that reverses the characters of a wireless security parameter to create an encrypted wireless security parameter, and uses the encrypted wireless security parameter as the broadcast SSID. A wireless device receiving the broadcast SSID implements a corresponding decryption algorithm that reverses the broadcast SSID to extract the wireless security parameter, and uses the wireless security parameter, and the broadcast SSID, to establish a secure wireless connection. A specific example can be a wireless security parameter of “123cba” (e.g., a WEP key or WPA-PSK) that is encrypted, by a broadcasting wireless device, to “abc321” (which is then used as the broadcast SSID) and decrypted by a receiving wireless device to “123cba”. The receiving wireless device can use the decrypted wireless security parameter to establish a secure wireless connection to the broadcasting wireless device (e.g., connect to the SSID “abc321” using the wireless security parameter “123cba”). Other simple encryption algorithms can be used as well, such as ROT-13.

Other types of encryption algorithms can be used to encrypt/decrypt wireless network connection information. For example, encryption algorithms that require the use of an encryption key that is known by both the encrypting device and the decrypting device can be used.

In an example implementation, a broadcasting wireless device can be pre-configured with an encryption algorithm and an encryption key. The broadcasting wireless device can receive a wireless security parameter (e.g., a WEP key or WPA-PSK entered by a user). The broadcasting wireless device can encrypt the wireless security parameter using the encryption algorithm and encryption key. The broadcasting wireless device can then broadcast the encrypted wireless security parameter as an SSID (e.g., a broadcast SSID). Wireless devices receiving the broadcast SSID (e.g., client wireless devices) can be pre-configured with a corresponding decryption algorithm and the encryption key (e.g., with the same encryption key as the broadcasting wireless device). The wireless devices receiving the broadcast SSID can decrypt the broadcast SSID, using the decryption algorithm and encryption key, to extract the wireless security parameter. The wireless devices receiving the broadcast SSID can use the wireless security parameter to establish a secure wireless connection to the broadcasting wireless device. A specific example can be a wireless security parameter of “567xyz” (e.g., a WEP key or WPA-PSK) that is encrypted, by a broadcasting wireless device using an encryption key of “my encryption key”, to “Orange” (which is then used as the broadcast SSID). A wireless device receiving the broadcast SSID of “Orange” can decrypt the broadcast SSID using the encryption key of “my encryption key”, to extract the wireless security parameter “567xyz”. The receiving wireless device can use the decrypted wireless security parameter to establish a secure wireless connection to the broadcasting wireless device (e.g., connect to the SSID “Orange” using the wireless security parameter “567xyz”).

In another example implementation, a broadcasting wireless device can be pre-configured with an encryption algorithm and an encryption key. The broadcasting wireless device can receive a wireless security parameter (e.g., a WEP key or WPA-PSK entered by a user) and a connection SSID (e.g., entered by a user). The broadcasting wireless device can encrypt the wireless security parameter and connection SSID using the encryption algorithm and encryption key (e.g., encrypt the wireless security parameter and connection SSID together, or encrypt each separately and combine them afterwards). The broadcasting wireless device can then broadcast the encrypted wireless security parameter and connection SSID as an SSID (e.g., a broadcast SSID). Wireless devices receiving the broadcast SSID (e.g., client wireless devices) can be pre-configured with a corresponding decryption algorithm and the encryption key (e.g., with the same encryption key as the broadcasting wireless device). The wireless devices receiving the broadcast SSID can decrypt the broadcast SSID, using the decryption algorithm and encryption key, to extract the wireless security parameter and connection SSID. The wireless devices receiving the broadcast SSID can use the wireless security parameter and connection SSID to establish a secure wireless connection to the broadcasting wireless device. A specific example can be a wireless security parameter of “567xyz” (e.g., a WEP key or WPA-PSK) and connection SSID of “Apple” that is encrypted, by a broadcasting wireless device using an encryption key of “my encryption key”, to “Orange” (which is then used as the broadcast SSID). A wireless device receiving the broadcast SSID of “Orange” can decrypt the broadcast SSID using the encryption key of “my encryption key”, to extract the wireless security parameter “567xyz” and connection SSID “Apple”. The receiving wireless device can use the decrypted wireless security parameter and connection SSID to establish a secure wireless connection to the broadcasting wireless device (e.g., connect to the SSID “Apple” using the wireless security parameter “567xyz”).

In another example implementation, an encryption algorithm, such as a steganographic technique, can be used to embed a wireless security parameter, or a combination of a wireless security parameter and a connection SSID, within a broadcast SSID. For example, specific bits (e.g., every third bit) of the characters making up the broadcast SSID can be altered to embed the wireless security parameter (or wireless security parameter and connection SSID).

In other example implementations, broadcasting and receiving wireless devices can be configured (e.g., pre-configured) with corresponding encryption/decryption algorithms, with or without using encryption keys. Wireless security parameters, with or without connection SSIDs, can be encrypted and broadcast as broadcast SSIDs. Wireless security parameters, with or without connection SSIDs, can be decrypted and used to establish secure wireless connections.

### Example 6—Exemplary Applications and Advantages

The examples, technologies, and techniques described herein for establishing secure wireless connections using encrypted SSID information can have many applications.

The examples, technologies, and techniques can be used to improve the security of ad-hoc wireless networks. For example, wireless devices that are to participate in an ad-hoc wireless network can be configured (e.g., pre-configured) with an encryption, and corresponding decryption, algorithm. Secure ad-hoc wireless connections can then be established using an encrypted wireless security parameter that is broadcast as a broadcast SSID. Only those wireless devices that are equipped with the decryption algorithm will be able to decrypt the broadcast SSID, obtain the wireless security parameter, and establish a secure ad-hoc wireless connection. Wireless devices that cannot decrypt the broadcast SSID (e.g., that are not equipped with the decryption algorithm) can have their connection attempts refused or ignored.

The security of ad-hoc wireless network can also be improved by encrypting wireless security parameters along with connection SSIDs. For example, wireless devices that are to participate in an ad-hoc wireless network can be configured (e.g., pre-configured) with an encryption, and corresponding decryption, algorithm. Secure ad-hoc wireless connections can then be established using an encrypted wireless security parameter and connection SSID that is broadcast as a broadcast SSID. Only those wireless devices that are equipped with the decryption algorithm will be able to decrypt the broadcast SSID, obtain the wireless security parameter and connection SSID, and establish a secure ad-hoc wireless connection. By using both a wireless security parameter and a connection SSID, further security can be provided. For example, connection attempts using the broadcast SSID can be ignored or refused. Only those wireless devices that attempt to connect using both the connection SSID (as the SSID value) and the wireless security parameter (e.g., as the WEP or WPA-PSK) can be allowed. Wireless devices that cannot decrypt the broadcast SSID (e.g., that are not equipped with the decryption algorithm) can have their connection attempts refused or ignored.

The technologies and techniques can also be applied to wireless networks operating in infrastructure mode.

### Example 7—Exemplary Method for Establishing Secure Wireless Connections

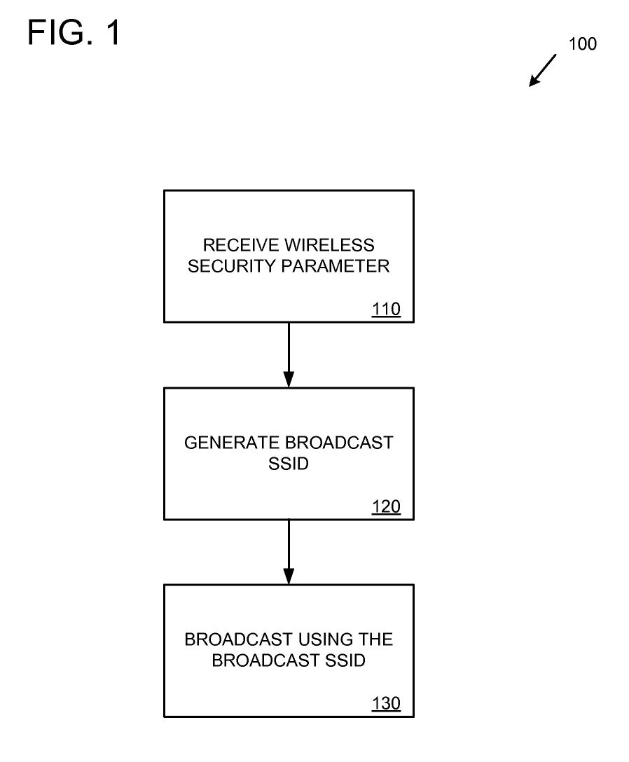

FIG. 1 shows an exemplary method 100 for establishing secure wireless connections by broadcasting wireless security parameters within SSID fields. At 110 a wireless security parameter is received. For example, the wireless security parameter can be a Wired Equivalent Privacy (WEP) key or a Wi-Fi Protected Access pre-shared key (WPA-PSK). The wireless security parameter can be created by a user. For example, a user of a wireless network device (e.g., a notebook computer equipped with a wireless network adapter) can enter the wireless security parameter.

At 120, a broadcast SSID is generated from the wireless security parameter. For example, an encryption algorithm can be used to generate the broadcast SSID by encrypting the wireless security parameter (e.g., the broadcast SSID can be the encrypted wireless security parameter). The encryption algorithm can encrypt the wireless security parameter using an encryption key. A wireless network device can automatically generate the broadcast SSID using the received wireless security parameter 110.

At 130, the broadcast SSID is broadcast within a wireless computing network. For example, a wireless network device can broadcast the broadcast SSID as an SSID value in the SSID field of beacon frames (e.g., in anticipation of accepting connections from client wireless network devices).

Once the broadcast SSID has been broadcast within the wireless computing network, secure wireless connections can be established. For example, a wireless device receiving the broadcast SSID (e.g., a client wireless device) can decrypt the broadcast SSID (e.g., using a decryption algorithm corresponding to the encryption algorithm used to generate the broadcast SSID) to obtain the wireless security parameter. The wireless device receiving the broadcast SSID can decrypt the broadcast SSID using the same encryption key as was used to encrypt the wireless security parameter. The wireless device can then establish a secure wireless connection using, at least in part, the wireless security parameter.

For example, a first wireless device can broadcast a broadcast SSID (e.g., an encrypted WEP key) in ad-hoc mode. A second wireless device can receive the broadcast SSID and decrypt the WEP key. The second wireless device can establish a secure wireless connection to the first wireless device by connecting to the first wireless device (e.g., connecting to the broadcast SSID) and using the WEP key.

### Example 8—Exemplary Encryption of a Wireless Security Parameter

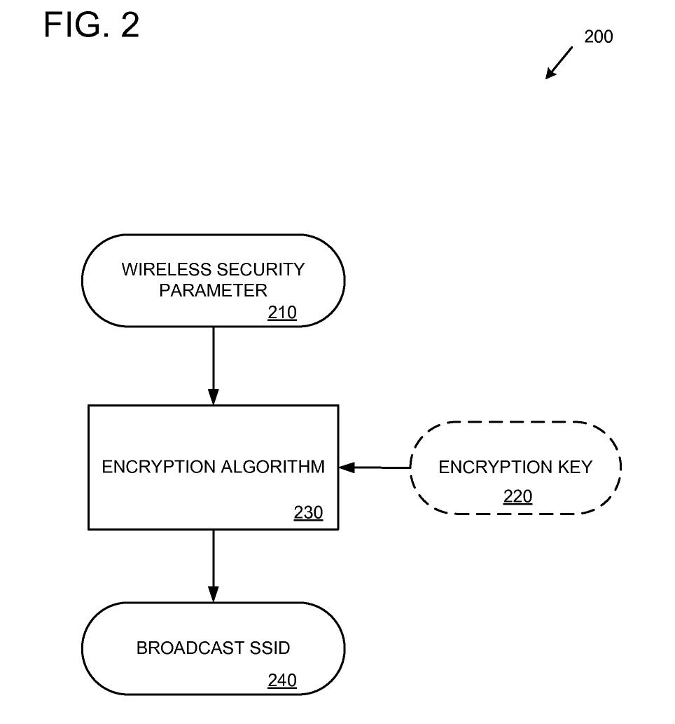

FIG. 2 depicts exemplary encryption of a wireless security parameter. In the example 200, an encryption algorithm 230 receives, as input, a wireless security parameter 210. The encryption algorithm 230 produces, as output, a broadcast SSID 240. In this example 200, the broadcast SSID 240 is the encrypted wireless security parameter 210. The encryption algorithm can optionally receive, as input, an encryption key 220 for use when performing the encryption.

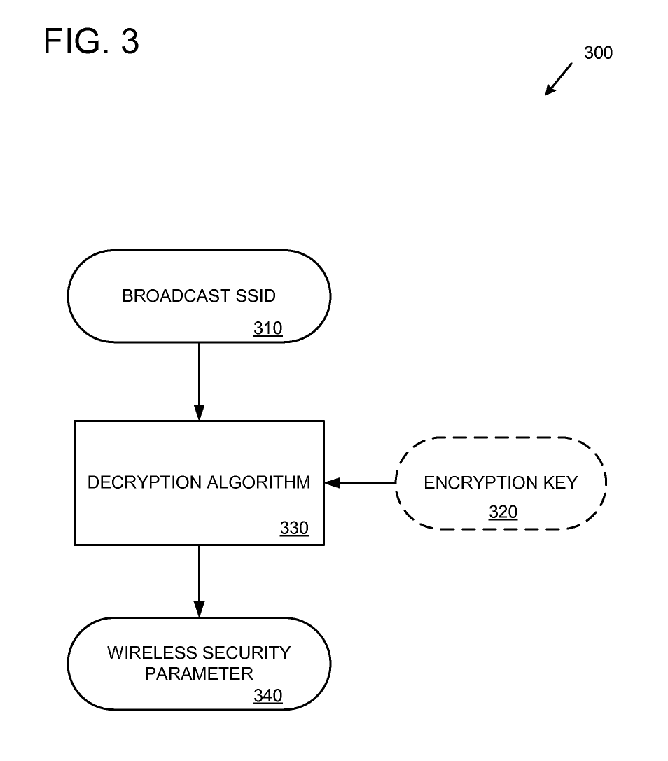

The example 200 can be implemented by a wireless device (e.g., implemented in hardware and/or software of the wireless device). For example, a wireless device accepting secure wireless connections (e.g., an access point operating in infrastructure mode or a wireless device operating in ad-hoc mode) can implement the example 200 in order to generate a broadcast SSID 240. The wireless device can broadcast the broadcast SSID 240 as an SSID value in SSID fields of beacon frames. Other wireless devices can receive the broadcast SSID 240, decrypt the wireless security parameter 210 (e.g., using the example depicted in FIG. 3), and use the wireless security parameter to establish a secure wireless connection to the wireless device.

### Example 9—Exemplary Decryption of a Broadcast SSID

FIG. 3 depicts exemplary decryption of a broadcast SSID. In the example 300, a decryption algorithm 330 receives, as input, a broadcast SSID 310. The decryption algorithm 330 produces, as output, a wireless security parameter 340. In this example 300, the wireless security parameter 340 is the decrypted broadcast SSID 310. The decryption algorithm can optionally receive, as input, an encryption key 320 for use when performing the decryption.

The example 300 can be implemented by a wireless device (e.g., implemented in hardware and/or software of the wireless device). For example, a wireless device can be configured to establish a secure wireless connection to another wireless device (e.g., to an access point operating in infrastructure mode or to a wireless device operating in ad-hoc mode). For example, a wireless device can receive the broadcast SSID 310. The wireless device can execute the decryption algorithm 330 to obtain the wireless security parameter 340 and use the wireless security parameter 340 to establish a secure wireless connection.

In this example 300, the decryption algorithm 330 corresponds to the encryption algorithm 230 of FIG. 2. Using the examples 200 and 300 together, a wireless security parameter 210 can be encrypted 230 to create a broadcast SSID 240 (corresponding to 310 in FIG. 3), which can be broadcast by a first wireless device (a wireless device accepting secure wireless connections). A second wireless device receiving the broadcast SSID 310 can decrypt 330 the broadcast SSID 310 to obtain the wireless security parameter 340 (corresponding to 210 in FIG. 2). The first and second wireless devices can be configured (e.g., pre-configured) with the same encryption key (220 and 320). The second wireless device can use the wireless security parameter 340 to establish a secure wireless connection to the first wireless device (e.g., in ad-hoc mode or in infrastructure mode). For example, the second wireless device can connect to the first wireless device using connection parameters comprising an SSID value of the broadcast SSID 310 and a WEP or WPA-PSK value of the wireless security parameter 340.

### Example 10—Exemplary System for Establishing Secure Wireless Connections

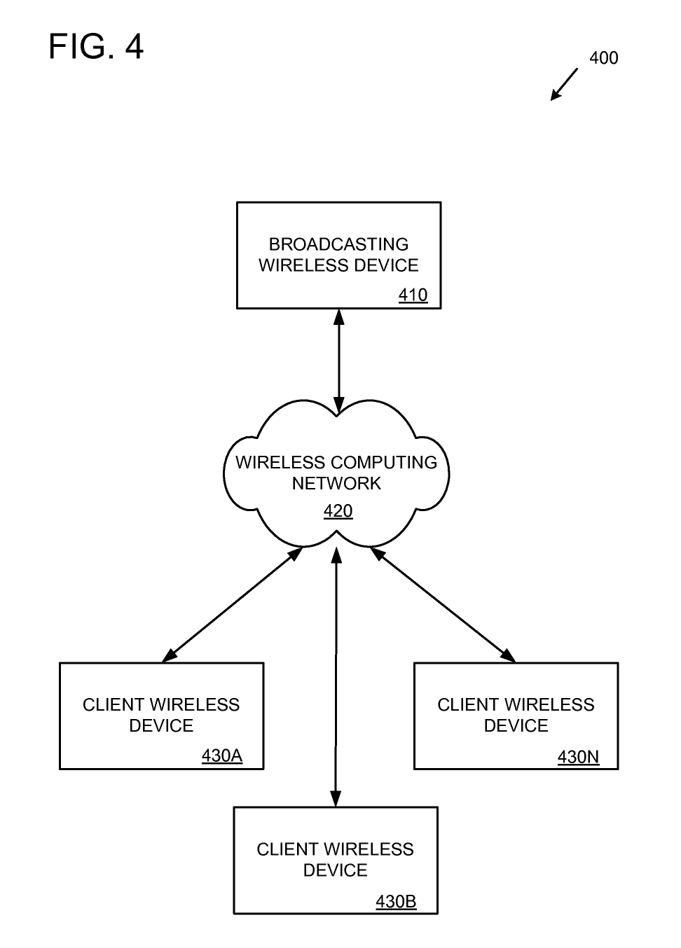

FIG. 4 shows an exemplary system 400 for establishing secure wireless connections. The exemplary system 400 includes a broadcasting wireless device 410. The broadcasting wireless device can be any wireless device configured to accept wireless connections (e.g., a wireless device operating in infrastructure mode or ad-hoc mode). The broadcasting wireless device 410 announces its availability for accepting connections by broadcasting an SSID. The broadcasting wireless device 410 broadcasts within the wireless computing network 420. The wireless computing network 420 can refer to a wireless network zone established by the broadcasting wireless device 410, and includes communications between the broadcasting wireless device 410 and any other wireless devices (e.g., client wireless devices 430A-N).

The broadcasting wireless device 410 can broadcast a broadcast SSID within the wireless computing network 420 to one or more client wireless devices, such as client wireless devices 430A-N. The broadcast SSID can comprise encrypted wireless security parameters. The broadcast SSID can also comprise encrypted connection SSIDs.

The broadcasting wireless device 410 can accept secure wireless connections from client wireless devices (e.g., 430A, 430B, or 430N) that connect using a specific SSID and a specific wireless security parameter. For example, the broadcasting wireless device 410 can accept secure wireless connections from client wireless devices that connect using an SSID broadcast by the broadcasting wireless device 410 and a wireless security parameter that has been decrypted from the broadcast SSID. If the specific SSID and wireless security parameter are not used by a client wireless device, the broadcasting wireless device 410 can refuse the connection (e.g., refuse to establish a secure wireless connection).

The broadcasting wireless device 410 can also accept secure wireless connections from client wireless devices that connect using a connection SSID and a wireless security parameter that have both been decrypted from a broadcast SSID broadcast by the broadcasting wireless device 410. If the specific connection SSID and wireless security parameter are not used by a client wireless device, the broadcasting wireless device 410 can refuse the connection (e.g., refuse to establish a secure wireless connection).

### Example 11—Exemplary System for Establishing Secure Wireless Connections by Broadcasting Wireless Security Parameters

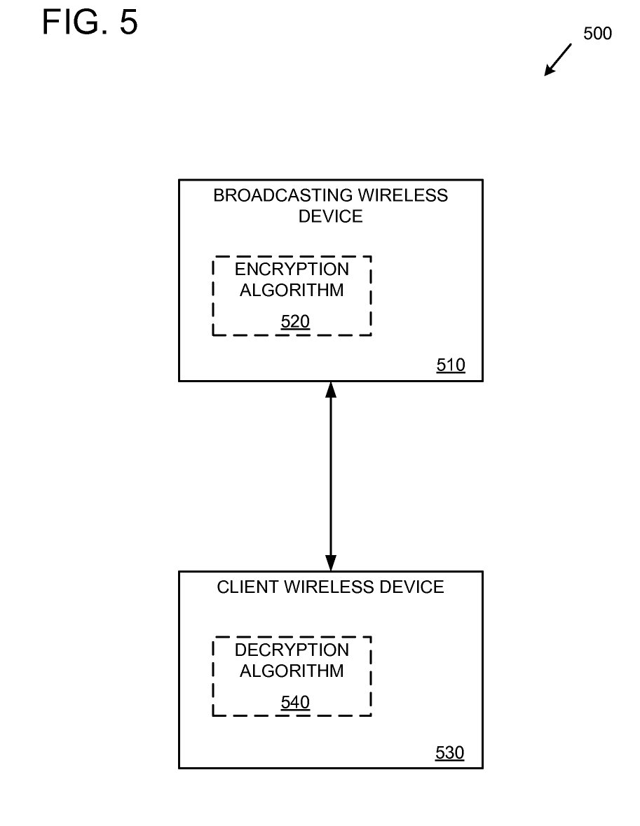

FIG. 5 shows an exemplary system 500 for establishing secure wireless connections by broadcasting wireless security parameters. The exemplary system 500 includes a broadcasting wireless device 510. The broadcasting wireless device can be any wireless device configured to broadcast an SSID and accept wireless connections (e.g., a wireless device operating in infrastructure mode or ad-hoc mode). The broadcasting wireless device 510 is configured (e.g., pre-configured) with an encryption algorithm 520. The broadcasting wireless device 510 can use the encryption algorithm 520 to encrypt a wireless security parameter or to encrypt a combination of a connection SSID and a wireless security parameter. The encryption algorithm 520 can be used to generate a broadcast SSID, which the broadcasting wireless device 510 can broadcast as an SSID value in the SSID field of beacon frames.

The exemplary system 500 also includes a client wireless device 530. The broadcasting wireless device 510 and client wireless device 530 can represent, for example, two wireless devices configured in ad-hoc mode. The client wireless device 530 is configured (e.g., pre-configured) with a decryption algorithm 540 used to decrypt information that has been encrypted with the encryption algorithm 520. For example, both the encryption algorithm 520 and the decryption algorithm 540 can be configured with the same encryption key. The client wireless device 530 can receive a broadcast SSID from the broadcasting wireless device 510. The client wireless device 530 can decrypt the broadcast SSID to extract a wireless security parameter or to extract a combination of a connection SSID and a wireless security parameter. The client wireless device 530 can then use the wireless security parameter, or the wireless security parameter and the connection SSID, to establish a secure connection with the broadcasting wireless device 510.

### Example 12—Exemplary Method for Establishing Secure Wireless Connections using Wireless Security Parameters and Connection SSIDs

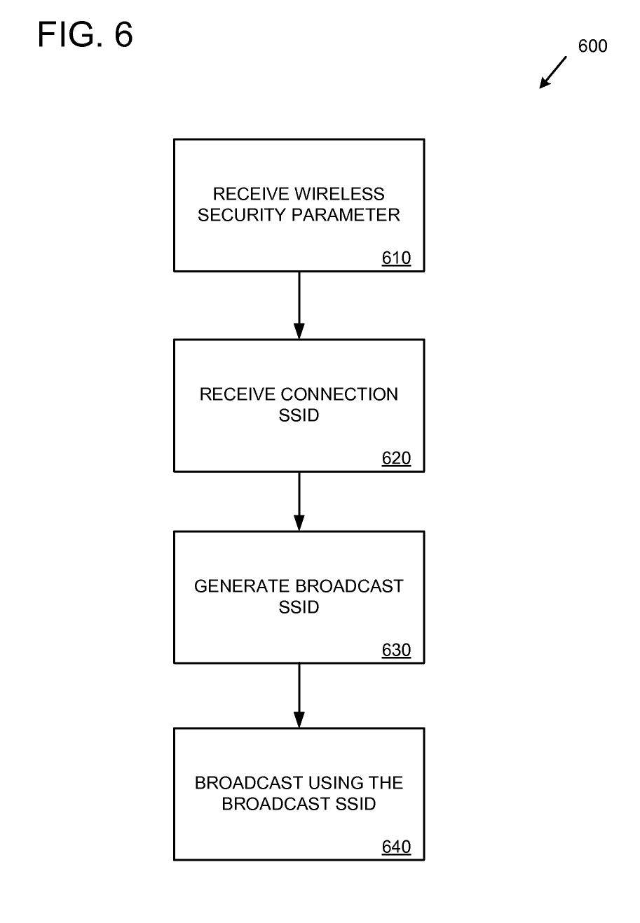

FIG. 6 shows an exemplary method 600 for establishing secure wireless connections by broadcasting wireless security parameters and connection SSIDs within SSID fields. At 610 a wireless security parameter is received. For example, the wireless security parameter can be a Wired Equivalent Privacy (WEP) key or a Wi-Fi Protected Access pre-shared key (WPA-PSK). The wireless security parameter can be created by a user. For example, a user of a wireless network device (e.g., a notebook computer equipped with a wireless network adapter) can enter the wireless security parameter.

At 620, a connection SSID is received. The connection SSID can be used to limit connections to those wireless devices which attempt to connect using the connection SSID as the SSID value. The connection SSID can be created by a user. For example, a user of a wireless network device (e.g., a notebook computer equipped with a wireless network adapter) can enter the connection SSID.

At 630, a broadcast SSID is generated from the wireless security parameter 610 and the connection SSID 620. For example, the broadcast SSID can be generated from a combination of the wireless security parameter and the connection SSID. An encryption algorithm can be used to generate the broadcast SSID by encrypting the wireless security parameter and connection SSID (e.g., the broadcast SSID can be the encrypted wireless security parameter and connection SSID). The encryption algorithm can encrypt the wireless security parameter and connection SSID using an encryption key. A wireless network device can automatically generate the broadcast SSID from the wireless security parameter 610 and connection SSID 620.

At 640, the broadcast SSID is broadcast within a wireless computing network. For example, a wireless network device can broadcast the broadcast SSID as an SSID value in the SSID field of beacon frames (e.g., in anticipation of accepting connections from client wireless network devices).

Once the broadcast SSID has been broadcast within the wireless computing network, secure wireless connections can be established. For example, a wireless device receiving the broadcast SSID can decrypt the broadcast SSID (e.g., using a decryption algorithm corresponding to the encryption algorithm used to generate the broadcast SSID) to obtain the wireless security parameter and connection SSID. The wireless device receiving the broadcast SSID can decrypt the broadcast SSID using the same encryption key as was used to encrypt the wireless security parameter and connection SSID. The wireless device can then establish a secure wireless connection using the wireless security parameter and connection SSID.

For example, a first wireless device can broadcast a broadcast SSID (e.g., an encrypted WEP key and connection SSID) in ad-hoc mode. A second wireless device can receive the broadcast SSID and decrypt the WEP key and connection SSID. The second wireless device can establish a secure wireless connection to the first wireless device by connecting to the first wireless device (e.g., connecting to the connection SSID) and using the WEP key.

### Example 13—Exemplary Encryption of a Wireless Security Parameter and Connection SSID

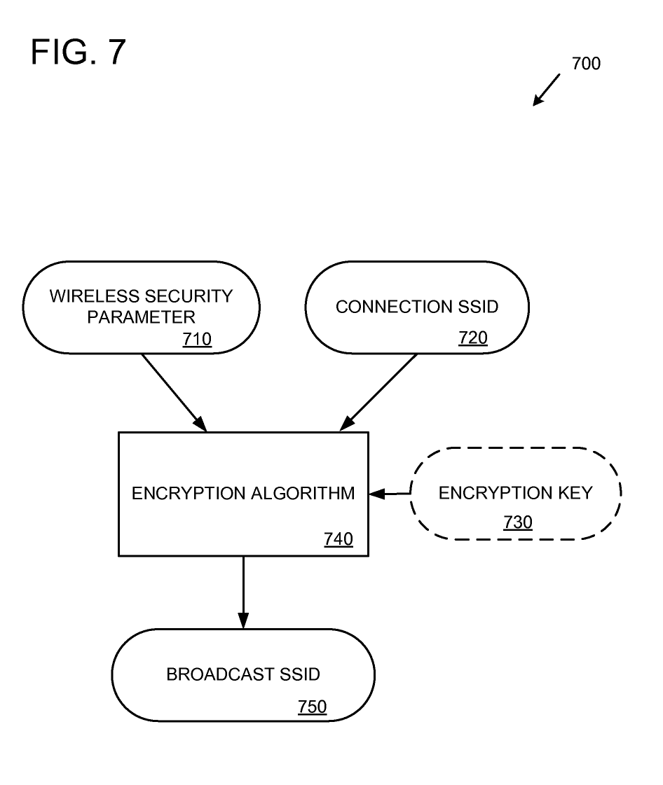

FIG. 7 depicts exemplary encryption of a wireless security parameter and connection SSID. In the example 700, an encryption algorithm 740 receives, as input, a wireless security parameter 710 and a connection SSID 720. The encryption algorithm 740 produces, as output, a broadcast SSID 750. In this example 700, the broadcast SSID 750 is the encrypted wireless security parameter 710 and connection SSID 720. For example, the wireless security parameter 710 and connection SSID 720 can be combined and then encrypted, or encrypted separately and combined afterwards. The encryption algorithm can optionally receive, as input, an encryption key 730 for use when performing the encryption.

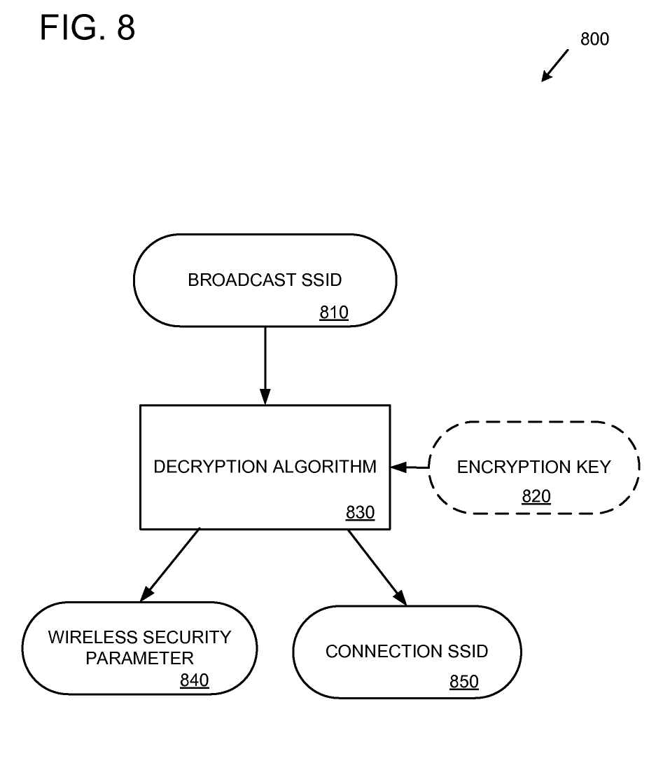

The example 700 can be implemented by a wireless device (e.g., implemented in hardware and/or software of the wireless device). For example, a wireless device accepting secure wireless connections (e.g., an access point operating in infrastructure mode or a wireless device operating in ad-hoc mode) can implement the example 700 in order to generate a broadcast SSID 750. The wireless device can broadcast the broadcast SSID 750 as an SSID value in SSID fields of beacon frames. Other wireless devices can receive the broadcast SSID 750, decrypt the wireless security parameter 710 and connection SSID 720 (e.g., using the example depicted in FIG. 8), and use the wireless security parameter and connection SSID to establish a secure wireless connection to the wireless device.

### Example 14—Exemplary Decryption of a Broadcast SSID

FIG. 8 depicts exemplary decryption of a broadcast SSID. In the example 800, a decryption algorithm 830 receives, as input, a broadcast SSID 810. The decryption algorithm 830 produces, as output, a wireless security parameter 840 and a connection SSID 850. The decryption algorithm can optionally receive, as input, an encryption key 820 for use when performing the decryption.

The example 800 can be implemented by a wireless device (e.g., implemented in hardware and/or software of the wireless device). For example, a wireless device can be configured to establish a secure wireless connection to another wireless device (e.g., to an access point operating in infrastructure mode or to a wireless device operating in ad-hoc mode). For example, a wireless device can receive the broadcast SSID 810. The wireless device can execute the decryption algorithm 830 to obtain the wireless security parameter 840 and connection SSID 850 and use the wireless security parameter 840 and connection SSID 850 to establish a secure wireless connection.

In this example 800, the decryption algorithm 830 corresponds to the encryption algorithm 740 of FIG. 7. Using the examples 700 and 800 together, a wireless security parameter 710 and connection SSID 720 can be encrypted 740 to create a broadcast SSID 750 (corresponding to 810 in FIG. 8), which can be broadcast by a first wireless device (a wireless device accepting secure wireless connections). A second wireless device receiving the broadcast SSID 810 can decrypt 830 the broadcast SSID 810 to obtain the wireless security parameter 840 (corresponding to 710 in FIG. 7) and connection SSID 850 (corresponding to 720 in FIG. 7). The first and second wireless devices can be configured (e.g., pre-configured) with the same encryption key (730 and 820). The second wireless device can use the wireless security parameter 840 and connection SSID 850 to establish a secure wireless connection to the first wireless device (e.g., in ad-hoc mode or in infrastructure mode). For example, the second wireless device can connect to the first wireless device using wireless connection parameters comprising an SSID value of the connection SSID 850 and a WEP or WPA-PSK value of the wireless security parameter 840.

### Example 15—Exemplary Method for Receiving Encrypted SSIDs

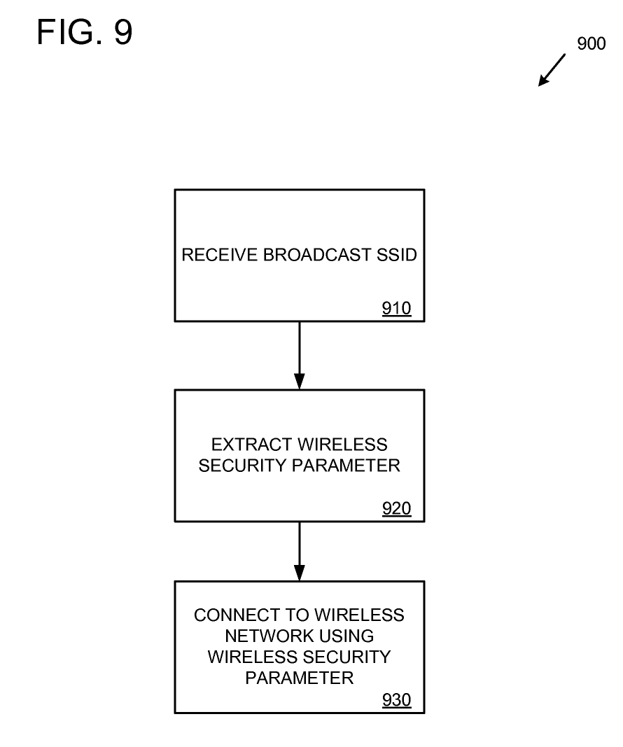

FIG. 9 shows an exemplary method 900 for receiving encrypted SSIDs. At 910, a wireless devices receives a broadcast SSID. The broadcast SSID contains encrypted information.

At 920, a wireless security parameter is extracted from the broadcast SSID. For example, a decryption algorithm can be executed to extract the wireless security parameter from the Broadcast SSID. In addition to a wireless security parameter, a connection SSID can also be extracted, using a decryption algorithm, from the broadcast SSID. The decryption process can use an encryption key (e.g., the same encryption key as was used during encryption).

At 930, a secure wireless connection is established using the wireless security parameter. For example, a secure wireless connection can be established to a wireless network using the wireless security parameter and the broadcast SSID. A secure wireless connection can also be established using the wireless security parameter and the connection SSID.

### Example 16—Exemplary Computing Environment

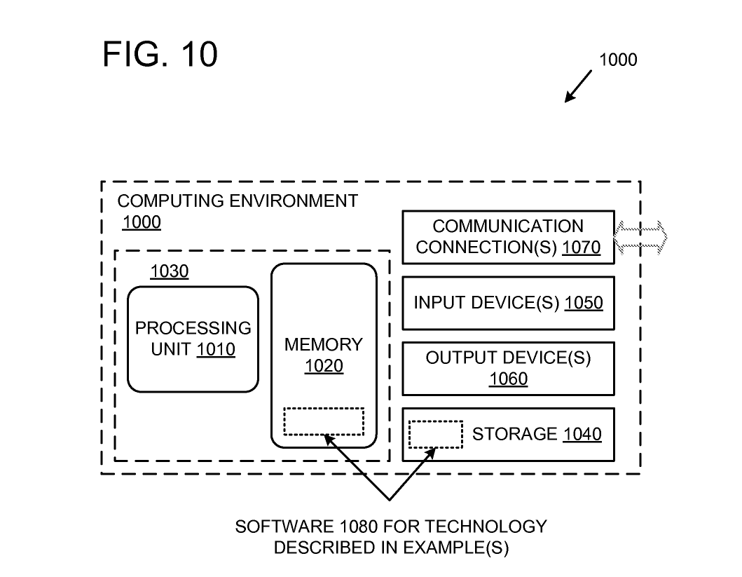

FIG. 10 illustrates a generalized example of a suitable computing environment 1000 in which described examples, embodiments, techniques, and technologies may be implemented. The computing environment 1000 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 10, the computing environment 1000 includes at least one central processing unit 1010 and memory 1020. In FIG. 10, this most basic configuration 1030 is included within a dashed line. The central processing unit 1010 executes computer-executable instructions and may be a real or a virtual processor. In a multi-processing system, multiple processing units execute computer-executable instructions to increase processing power and as such, multiple processors can be running simultaneously. The memory 1020 may be volatile memory (e.g., registers, cache, RAM), non-volatile memory (e.g., ROM, EEPROM, flash memory, etc.), or some combination of the two. The memory 1020 stores software 1080 that can, for example, implement the technologies described herein. A computing environment may have additional features. For example, the computing environment 1000 includes storage 1040, one or more input devices 1050, one or more output devices 1060, and one or more communication connections 1070. An interconnection mechanism (not shown) such as a bus, a controller, or a network, interconnects the components of the computing environment 1000. Typically, operating system software (not shown) provides an operating environment for other software executing in the computing environment 1000, and coordinates activities of the components of the computing environment 1000.

The storage 1040 may be removable or non-removable, and includes magnetic disks, magnetic tapes or cassettes, CD-ROMs, CD-RWs, DVDs, or any other medium which can be used to store information and which can be accessed within the computing environment 1000. The storage 1040 stores instructions for the software 1080, which can implement technologies described herein.

The input device(s) 1050 may be a touch input device, such as a keyboard, keypad, mouse, pen, or trackball, a voice input device, a scanning device, or another device, that provides input to the computing environment 1000. For audio, the input device(s) 1050 may be a sound card or similar device that accepts audio input in analog or digital form, or a CD-ROM reader that provides audio samples to the computing environment 1000. The output device(s) 1060 may be a display, printer, speaker, CD-writer, or another device that provides output from the computing environment 1000.

The communication connection(s) 1070 enable communication over a communication medium (e.g., a connecting network) to another computing entity. The communication medium conveys information such as computer-executable instructions, compressed graphics information, or other data in a modulated data signal.

Computer-readable media are any available media that can be accessed within a computing environment 1000. By way of example, and not limitation, with the computing environment 1000, computer-readable media include memory 1020, storage 1040, communication media (not shown), and combinations of any of the above.

### Example 17—Exemplary Automated Methods

Any of the methods described herein can be performed via one or more computer-readable media (e.g., storage or other tangible media) having computer-executable instructions for performing (e.g., causing a computing device or computer to perform) such methods. Operation can be fully automatic, semi-automatic, or involve manual intervention.

### Example 18—Exemplary Combinations

The technologies of any example described herein can be combined with the technologies of any one or more other examples described herein.

### Example 19—Exemplary Alternatives

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method, implemented at least in part by a computing device, for establishing secure wireless connections within a wireless computing network by broadcasting wireless security parameters within SSID fields, the method comprising:
receiving a wireless security parameter used for establishing a secure connection to the wireless computing network;
generating a broadcast SSID from the wireless security parameter, wherein the generating obscures the wireless security parameter;
broadcasting the broadcast SSID within the wireless computing network; and
establishing secure connections with one or more client wireless devices when the one or more client wireless devices connect using the broadcast SSID and the wireless security parameter.

2. The method of claim 1 wherein the broadcast SSID is generated from the wireless security parameter using an encryption algorithm, and wherein the broadcast SSID comprises the encrypted wireless security parameter.

3. The method of claim 2 further comprising:
receiving an encryption key;
wherein the encryption algorithm uses the encryption key when encrypting the wireless security parameter.

4. The method of claim 1 wherein the broadcast SSID is broadcast in an SSID field of a beacon frame.

5. The method of claim 1 wherein the wireless security parameter is a WEP key or a WPA-PSK.

6. The method of claim 1 wherein the broadcast SSID is generated from the wireless security parameter using a cipher algorithm.

7. The method of claim 1 wherein the wireless security parameter is embedded within the broadcast SSID.

8. The method of claim 1 wherein the one or more client wireless devices receive the broadcast SSID and decrypt the broadcast SSID to obtain the wireless security parameter.

9. The method of claim 1 further comprising:
refusing to establish secure connections with one or more other client wireless devices when the one or more other client wireless devices attempt to connect using the broadcast SSID and without using the wireless security parameter.

10. One or more computer-readable media comprising computer-executable instructions for causing a computing device to perform the method of claim 1.

11. A method, implemented at least in part by a computing device, for establishing secure wireless connections within a wireless computing network by broadcasting wireless security parameters within SSID fields, the method comprising:
receiving a wireless security parameter used for establishing a secure connection to the wireless computing network;
receiving a connection SSID;
generating a broadcast SSID from a combination of the wireless security parameter and the connection SSID, wherein the generating obscures the wireless security parameter and the connection SSID;
broadcasting, in an SSID field of a beacon frame, the broadcast SSID; and
establishing secure connections with one or more client wireless devices when the one or more client wireless devices connect using the connection SSID and the wireless security parameter.

12. The method of claim 11 wherein the one or more client wireless devices receive the broadcast SSID, extract the connection SSID and the wireless security parameter from the broadcast SSID using a decryption algorithm, and connect using the extracted connection SSID and the extracted wireless security parameter.

13. The method of claim 11 wherein the broadcast SSID is generated from the wireless security parameter and the connection SSID using an encryption algorithm, and wherein the broadcast SSID comprises the encrypted wireless security parameter and the encrypted connection SSID.

14. The method of claim 13 further comprising:
receiving an encryption key;
wherein the encryption algorithm uses the encryption key when encrypting the wireless security parameter and the connection SSID.

15. The method of claim 11 wherein the wireless security parameter is a WEP key or a WPA-PSK.

16. The method of claim 11 wherein the broadcast SSID is generated from the wireless security parameter and the connection SSID using a cipher algorithm.

17. The method of claim 11 further comprising:
refusing to establish secure connections with one or more other client wireless devices when the one or more other client wireless devices attempt to connect using the broadcast SSID.

18. The method of claim 11 further comprising:
refusing to establish secure connections with one or more other client wireless devices when the one or more other client wireless devices attempt to connect using the connection SSID and without using the wireless security parameter.

19. A wireless computing device for establishing secure wireless connections by broadcasting wireless security parameters within SSID fields, the wireless computing device comprising:
a wireless module configured to generate a broadcast SSID and broadcast the broadcast SSID in SSID fields of beacon frames within a wireless computing network,
wherein the broadcast SSID comprises a wireless security parameter for establishing a secure connection to the wireless computing device, and wherein the wireless security parameter is obscured within the broadcast SSID;
wherein one or more client wireless devices receive the broadcast SSID, extract the wireless security parameter, and use the wireless security parameter when connecting to the wireless computing device.

20. The wireless computing device of claim 19 wherein the wireless computing device has been pre-configured with an encryption algorithm, wherein the one or more client wireless devices have been pre-configured with a decryption algorithm for decrypting information encrypted by the encryption algorithm, wherein the encryption algorithm is used by the wireless computing device to generate the broadcast SSID from the wireless security parameter, and wherein the decryption algorithm is used by the one or more client wireless devices to decrypt the broadcast SSID to obtain the wireless security parameter.

21. The wireless computing device of claim 19 wherein the one or more client wireless devices connect to the wireless computing device using the broadcast SSID and the wireless security parameter.

22. The wireless computing device of claim 19 wherein the broadcast SSID further comprises a connection SSID, and wherein the connection SSID is obscured within the broadcast SSID.

23. The wireless computing device of claim 22 wherein the wireless computing device has been pre-configured with an encryption algorithm, wherein the one or more client wireless devices have been pre-configured with a decryption algorithm for decrypting information encrypted by the encryption algorithm, wherein the encryption algorithm is used by the wireless computing device to generate the broadcast SSID from the wireless security parameter and the connection SSID, and wherein the decryption algorithm is used by the one or more client wireless devices to decrypt the broadcast SSID to obtain the wireless security parameter and the connection SSID.

24. The wireless computing device of claim 22 wherein the one or more client wireless devices connect to the wireless computing device using the connection SSID and the wireless security parameter.

25. The wireless computing device of claim 19 wherein the wireless security parameter is a WEP key or a WPA-PSK.

26. The wireless computing device of claim 19 wherein the wireless computing network is an 802.11 wireless network, wherein the wireless computing device comprises a standard 802.11 wireless network adapter, and wherein the one or more client wireless devices comprise standard 802.11 wireless network adapters.
